(19) United States
(12) Patent Application Publication
(10) Pub. No.: US 2021/0229212 A1
(43) Pub. Date: Jul. 29, 2021

(54) LASER PROCESSING METHOD, LASER PROCESSING APPARATUS, AND OUTPUT CONTROL DEVICE OF LASER PROCESSING APPARATUS

(71) Applicant: Panasonic Intellectual Property Management Co., Ltd., Osaka (JP)

(72) Inventor: MASAHIRO MORI, Osaka (JP)

(21) Appl. No.: 17/098,509

(22) Filed: Nov. 16, 2020

(30) Foreign Application Priority Data
Jan. 28, 2020 (JP) 2020-012035

(51) Int. Cl. B23K 26/00; B23K 26/03; B23K 26/60

(52) U.S. Cl. CPC B23K 26/0006; B23K 2103/10; B23K 26/60; B23K 26/032

(57) ABSTRACT

A laser processing apparatus of the present disclosure controls outputs of a blue laser oscillator and an infrared laser oscillator such that before a surface oxidation is detected on a workpiece, the workpiece is irradiated with at least blue laser light, and after the surface oxidation is detected on the workpiece, power of infrared laser light with which the workpiece is irradiated is increased as compared to before the surface oxidation is detected.

### BACKGROUND

### 1. Technical Field

The present disclosure relates to a laser processing method, a laser processing apparatus, and an output control device of the laser processing apparatus.

### 2. Description of the Related Art

A laser processing apparatus is widely used for various processing such as micro-processing, welding, marking, or cutting. Since the laser processing apparatus locally collects energy of laser beam and irradiates a workpiece with laser light having high energy density, high definition processing can be realized at high speed.

The laser light has a drawback that it has a poor absorption rate (in other words, has a high reflectance) for copper, aluminum, an aluminum alloy, or the like, which is the workpiece. As a result, it is necessary to irradiate the workpiece with laser light having high power.

On the other hand, a workpiece such as aluminum alloy has characteristics that once the workpiece melts, the reflectance of the workpiece with respect to the laser light decreases, and the absorption rate increases. Focusing on this point, in the related art, a technique for rapidly transitioning a surface of the workpiece to a melting state has been developed.

For example, in Japanese Patent Unexamined Publication No. 2002-316282, in an initial processing stage of a workpiece, a technique for accelerating a surface melting of a workpiece by irradiating the workpiece with pulse laser light having high power in addition to semiconductor laser light having low power is disclosed.

### SUMMARY

According to an aspect of the present disclosure, there is provided a laser processing method including: a first irradiation step of irradiating a workpiece with at least laser light having a first wavelength at an initial processing stage before at least one of a surface oxidation and a surface melting of the workpiece; a surface state detection step of detecting the at least one of the surface oxidation and the surface melting of the workpiece; and a second irradiation step of irradiating the workpiece with laser light having a second wavelength which is different from the first wavelength after the at least one of the surface oxidation and the surface melting is detected in the surface state detection step, wherein the laser light having the second wavelength with which the workpiece is irradiated in the second irradiation step has a power higher than a power before the at least one of the surface oxidation and the surface melting is detected.

According to an aspect of the present disclosure, there is provided a laser processing apparatus including: a laser light former that forms first laser light and second laser light having different wavelengths, respectively, as laser light with which a workpiece is irradiated; a surface state detector that detects at least one of a surface oxidation and a surface melting of the workpiece; and an output controller that controls a power of the first laser light and a power of the second laser light output by the laser light former, wherein the output controller causes the laser light former to: before the at least one of the surface oxidation and the surface melting is detected on the workpiece, irradiate the workpiece with at least the first laser light; and after the at least one of the surface oxidation and the surface melting is detected on the workpiece, increasing the power of the second laser light with which the workpiece is irradiated as compared to before the at least one of the surface oxidation and the surface melting is detected.

According to an aspect of the present disclosure, there is provided an output control device of a laser processing apparatus including: an output controller that controls a power of laser light with which a workpiece is irradiated; and a surface state detector that detects at least one of a surface oxidation and a surface melting of the workpiece, wherein the output controller controls the power of the laser light to: before the at least one of the surface oxidation and the surface melting is detected on the workpiece, irradiate the workpiece with at least laser light having a first wavelength, and after the at least one of the surface oxidation and the surface melting is detected on the workpiece, irradiate the workpiece with laser light having a second wavelength which is different from the first wavelength, and increase a power of the laser light having the second wavelength with which the workpiece is irradiated after the at least one of the surface oxidation and the surface melting is detected to be higher than a power before the at least one of the surface oxidation and the surface melting is detected.

### BRIEF DESCRIPTION OF THE DRAWINGS

FIG. 1 is a schematic diagram illustrating a main configuration of a laser processing apparatus according to an exemplary embodiment; and

FIG. 2 is a diagram provided for explaining an operation of the laser processing apparatus of the exemplary embodiment.

FIG. 3 is a diagram illustrating a relationship between a wavelength and an absorption rate of laser light with respect to a workpiece.

### DETAILED DESCRIPTION

When a laser processing method of Japanese Patent Unexamined Publication No. 2002-316282 is used, the melting of the workpiece is accelerated and the surface of the workpiece can be quickly transferred to the melting state but there is a possibility that spatter, voids, or the like may be generated because a keyhole is formed in a laser irradiation portion of the workpiece by the pulsed laser light having a high power.

The present disclosure has been made in consideration of the above points and provides a laser processing method, a laser processing apparatus, and an output control device for the laser processing apparatus capable of performing laser processing with high quality and high speed.

### <1> Background to Present Disclosure

First, before explaining an exemplary embodiment of the present disclosure, the background to the present disclosure will be described.

The inventor of the present disclosure considered using laser light having different wavelengths, more specifically, both blue laser light and infrared laser light for laser processing. A wavelength of the blue laser light is 380 to 500 [nm], and a wavelength of the infrared laser light is 700 to 1100 [nm]. The blue laser light has a feature of a high absorption rate into a workpiece, and the infrared laser light has a feature of a good beam quality (beam parameter products (BPP) or M square (M2) are small).

With respect to the workpiece such as copper, aluminum, or an aluminum alloy, the infrared laser light has a drawback that the absorption rate is low in an initial processing stage before a surface melting of the workpiece. To compensate for this, it is conceivable to irradiate the workpiece with the infrared laser light having a high power before the surface melting to accelerate the melting but in this way, a rapid temperature rise occurs when a solid and liquid phase of the workpiece changes, so that the melting becomes unstable and the spatter or recessed holes are generated.

In contrast to this, with respect to the workpiece such as copper, aluminum, or an aluminum alloy, the blue laser light has an advantage that the absorption rate is higher than that of the infrared laser light in the initial processing stage before the surface melting of the workpiece. Therefore, when the blue laser light is used, the melting state can be formed with a lower power than that of the infrared laser light, so that the melting state can be stabilized and the generation of the spatter and recessed holes can be suppressed.

However, it is difficult to realize a laser apparatus for generating blue laser light having a high power. As a result, when a blue laser is used, even after the melting of the workpiece, it is necessary to irradiate the workpiece with the blue laser light having a low power, and it is difficult to secure a sufficient melt volume in the workpiece.

Therefore, the inventor considered that the laser processing with high quality and high speed could be realized by using both blue laser light and infrared laser light and appropriately selecting the irradiation timing thereof, and accordingly the present disclosure has come to be made.

The inventor also noted that when the workpiece is irradiated with a laser, there is a state in which a surface of the workpiece is oxidized as a stage before the surface melts, and even in this surface oxidation state, the absorption rate of infrared laser light increases.

One of the features of the laser processing method and apparatus of the present disclosure is that at the initial processing stage before the surface oxidation of the workpiece, the workpiece is irradiated with at least the blue laser light, and after the surface oxidation of the workpiece is detected, the workpiece is irradiated with the infrared laser light having a power higher than the power before the surface oxidation is detected.

In this way, at the initial processing stage of the workpiece, the surface oxidation of the workpiece is accelerated by the blue laser light, and the workpiece is irradiated with the infrared laser light having a high power in a state where the absorption rate of the infrared laser light has increased due to the surface oxidation, thereby efficient laser processing can be performed. As compared with the case where the power of the infrared laser light is increased after the surface melting is detected, the power of the infrared laser light is increased from an earlier stage, so that the processing time can be shortened and faster laser processing can be realized.

### <2> Exemplary Embodiment

Hereinafter, an exemplary embodiment of the present disclosure will be described with reference to the drawings.

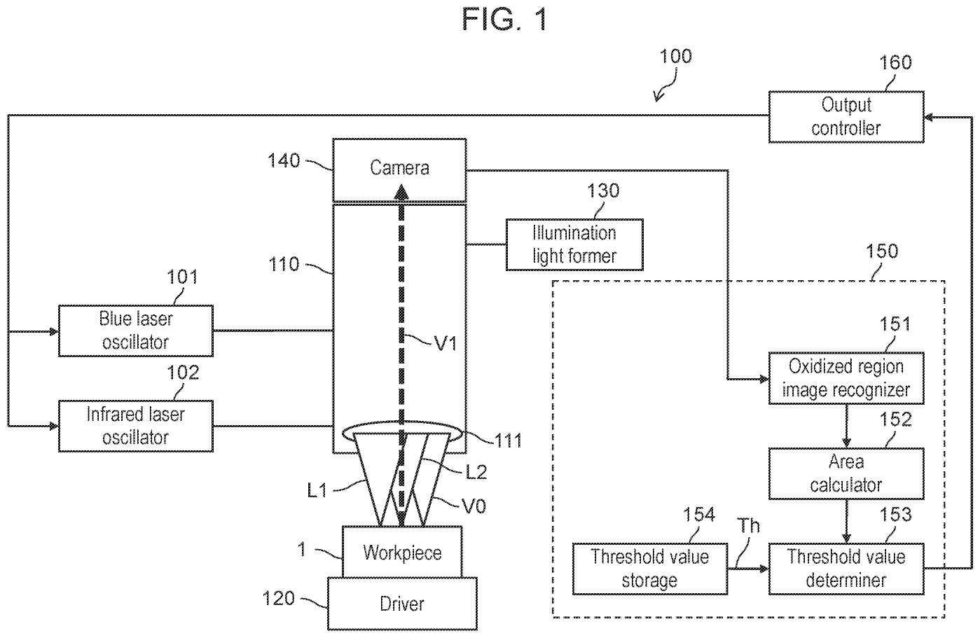

FIG. 1 is a schematic diagram illustrating a main configuration of laser processing apparatus 100 according to the exemplary embodiment of the present disclosure.

Laser processing apparatus 100 includes blue laser oscillator 101, infrared laser oscillator 102, laser head 110, driver 120, illumination light former 130, camera 140, calculator 150, and output controller 160.

Blue laser light obtained by blue laser oscillator 101 and infrared laser light obtained by infrared laser oscillator 102 are incident on laser head 110.

Laser head 110 has condenser lens 111. A surface of workpiece 1 is irradiated with blue laser light L1 and infrared laser light L2, which are incident on laser head 110, by condenser lens 111.

Although blue laser light L1 and infrared laser light L2 are described so as to be shifted from each other in FIG. 1 for convenience, but actually, the same point on workpiece 1 is irradiated with blue laser light L1 and infrared laser light L2. For example, blue laser light L1 and infrared laser light L2, which are guided by laser head 110, are superimposed inside laser head 110 by a wavelength synthesis method (not illustrated) such as a dichroic mirror or a prism, and the same point on workpiece 1 is irradiated with blue laser light L1 and infrared laser light L2. When a laser irradiation is performed together with a scanning, blue laser light L1 may be preceded first and a position shifted to a rear side of the scanning from blue laser light L1 may be irradiated with infrared laser light L2.

Driver 120 moves workpiece 1 in a plane direction orthogonal to optical axes of laser light L1 and L2.

Illumination light former 130 forms illumination light V0 with which the surface of workpiece 1 is irradiated. Illumination light V0 may be light having a wavelength at which oxidation of the surface of workpiece 1 can be detected as an image. Illumination light V0 is light having a wavelength other than that used for processing and may be light having a wavelength at which the oxidation state can be detected by camera 140. As illumination light V0, for example, it is desirable to use visible light.

Camera 140 as a capture unit inputs reflected light V1 of illumination light V0 from workpiece 1, obtains a captured image signal based on reflected light V1, and transmits the captured image signal to oxidized region image recognizer 151 of calculator 150.

Oxidized region image recognizer 151 detects a discolored region in a captured image and recognizes this discolored region as an oxidized region. For example, a region discolored in red is recognized as an oxidized region. However, oxidized region image recognizer 151 does not necessarily have to recognize the oxidized region based on the discoloration, and may recognize the oxidized region based on, for example, a change in the gloss or roughness of the surface.

Area calculator 152 calculates an area of the oxidized region. Threshold value determiner 153 performs a threshold value determination on an area of the oxidized region using threshold value Th stored in threshold value storage 154 and transmits the determination result to output controller 160.

Output controller 160 controls the outputs of blue laser oscillator 101 and infrared laser oscillator 102 based on the determination result. When the determination result that the area of the oxidized region is larger than or equal to threshold value Th is input (in other words, when the surface oxidation is detected), output controller 160 controls the outputs of blue laser oscillator 101 and infrared laser oscillator 102 such that the power of infrared laser light L2 is increased as compared with the power before the surface oxidation is detected.

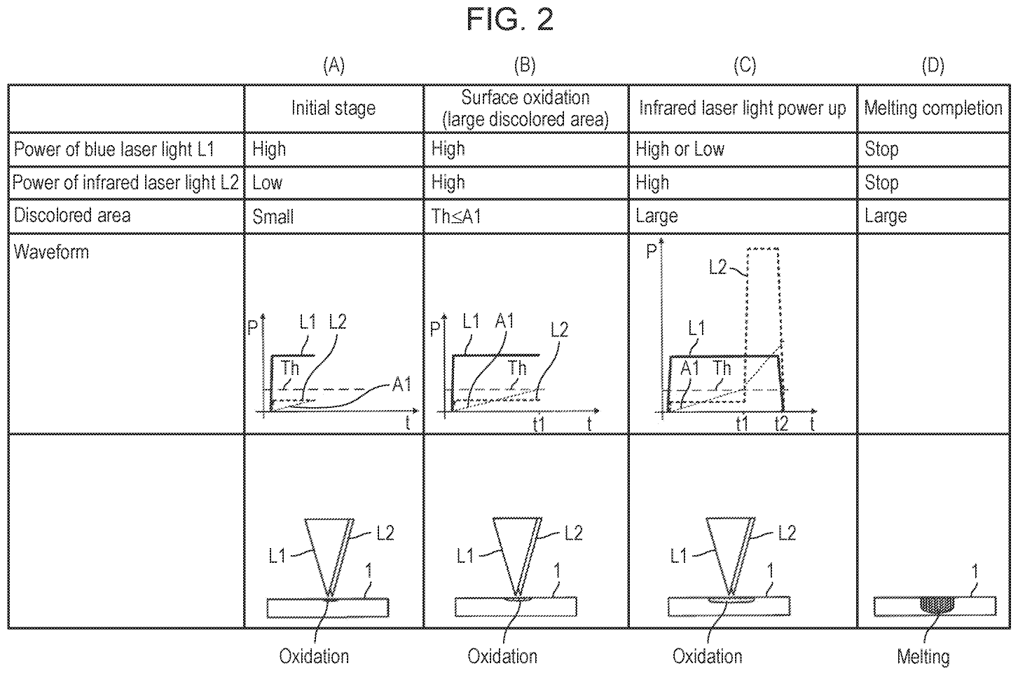

FIG. 2 is a diagram provided for explaining an operation of laser processing apparatus 100 of the present exemplary embodiment.

First, as illustrated in (A) of FIG. 2, at the initial processing stage before the surface oxidation of workpiece 1, laser processing apparatus 100 irradiates workpiece 1 with blue laser light L1 and infrared laser light L2. At this time, blue laser light L1 is controlled with a high power, and infrared laser light L2 is controlled with a low power. However, as described above, although blue laser light L1 has a high power, it has a very low power as compared with the high power of infrared laser light L2 (see (C) of FIG. 2).

In the state in (A) of FIG. 2, the surface oxidation and the surface melting are accelerated by blue laser light L1 having a high absorption rate with respect to workpiece 1 such as copper or aluminum alloy. In (A) of FIG. 2, discolored area A1 due to oxidation of the surface of workpiece 1 is smaller than threshold value Th.

Eventually, as illustrated in (B) of FIG. 2, the oxidation of the surface of workpiece 1 progresses, and discolored area A1 becomes large and becomes equal to threshold value Th (time t1). In this way, when discolored area A1 becomes equal to threshold value Th, laser processing apparatus 100 transitions a state to the state illustrated in (C) of FIG. 2.

As illustrated in (C) of FIG. 2, after time t1 when discolored area A1 becomes larger than or equal to threshold value Th (that is, after the surface oxidation is detected), laser processing apparatus 100 increases the power of infrared laser light L2. In this way, after the surface oxidation with an increased absorption rate for infrared laser light L2, the laser processing that secures a sufficient melt volume can be performed by infrared laser light L2 having a high power. Incidentally, blue laser light L1 after the surface oxidation is detected may be controlled with the high power as illustrated in the example of FIG. 2, or may be controlled with the low power.

Eventually, when the desired melting with respect to workpiece 1 is completed at time t2, as illustrated in (D) of FIG. 2, laser processing apparatus 100 stops outputs of blue laser light L1 and infrared laser light L2 from blue laser oscillator 101 and infrared laser oscillator 102.

As described above, according to laser processing apparatus 100 of the present exemplary embodiment, at the initial processing stage before the surface oxidation of workpiece 1, workpiece 1 is irradiated with at least blue laser light L1, and after the surface oxidation of workpiece 1 is detected, workpiece 1 is irradiated with infrared laser light L2 having a power higher than the power before the surface oxidation is detected.

In this way, the surface oxidation of workpiece 1 is accelerated by blue laser light L1 having a high absorption rate into workpiece 1, and after the surface oxidation with an increased absorption rate for infrared laser light L2 since the melt volume is secured by infrared laser light L2 having a high power, the laser processing with high quality and high speed can be performed.

### <3> Other Exemplary Embodiments

The above-described exemplary embodiment is merely an example of the exemplary embodiment of the present disclosure, and the technical scope of the present disclosure should not be construed in a limited manner by these. That is, the present disclosure can be implemented in various forms without departing from its gist or its main features.

In the above-described exemplary embodiment, at the initial processing stage before the surface oxidation of workpiece 1, the case where workpiece 1 is irradiated with infrared laser light L2 in addition to blue laser light L1 has been described but at the initial processing stage, it is not always necessary to irradiate workpiece 1 with infrared laser light L2.

However, in a case where the workpiece 1 is irradiated with infrared laser light L2 having a low power before the surface oxidation as in the above-described exemplary embodiment, when workpiece 1 is irradiated with infrared laser light L2 having a high power after the surface oxidation is detected, infrared laser light L2 rises faster and there is an advantage that the processing accuracy is improved.

It is more desirable that blue laser light L1 after the surface oxidation is detected is controlled to increase or decrease depending on a surface oxidation state detected by the oxidation detection. For example, when the power of blue laser light L1 after the surface oxidation is adjusted based on an amount of change in a level of reflected light L3 of infrared laser light L2 (=the speed of growth of the initial oxidation), the melting after the surface oxidation can be made more stable. For example, when the amount of change in discolored area A1 is large, that is, when the initial oxidation progresses rapidly, there is a possibility that spatter or voids may be generated due to blue laser light L1. Therefore, in such a case, it is desirable to maintain a good amount of change and stabilize the quality by lowering the power of blue laser light L1. On the contrary, when the amount of change in discolored area A1 is small, the initial oxidation may be insufficient, so it is desirable to increase the power of blue laser light L1.

In the above-described exemplary embodiment, the case where blue laser light L1 and infrared laser light L2 are used has been described, but the present disclosure is not limited to this, the idea of the present disclosure is widely applicable when first and second laser light having different wavelengths are used.

That is, at the initial processing stage before the surface oxidation of the workpiece, the workpiece may be irradiated with the first laser light having a good absorption rate into the workpiece out of at least the first and second laser light, and after the surface oxidation is detected (that is, after the absorption rate of the second laser light is increased), the workpiece may be irradiated with the second laser light having the power higher than the power before the surface oxidation is detected.

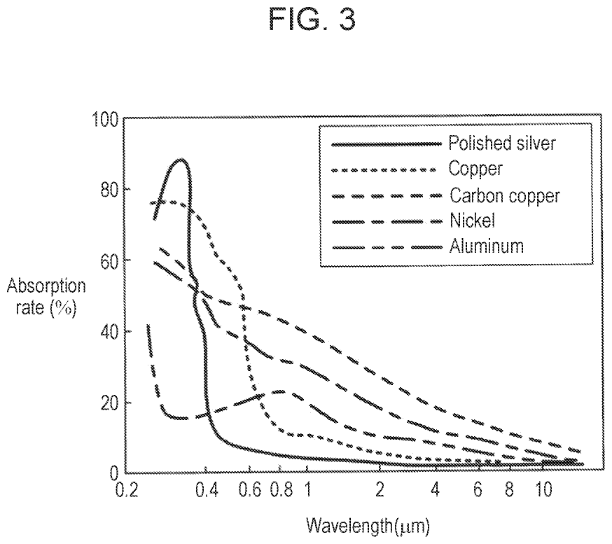

FIG. 3 is a diagram illustrating a relationship between the wavelength and the absorption rate of the laser light with respect to the workpiece before oxidation or melting.

In general, as illustrated in FIG. 3, before the surface oxidation and the surface melting of the workpiece, the laser light having a short wavelength has a better absorption rate than the laser light having a long wavelength, thereby it satisfies, (wavelength of the first laser light)<(wavelength of the second laser light). However, depending on the type of the workpiece and the wavelength of the laser light used, it may satisfy, (wavelength of the first laser light)>(wavelength of the second laser light). For example, when the workpiece is glass, resin, or the like, the relationship may satisfy, (wavelength of the first laser light)>(wavelength of the second laser light).

That is, the relationship between the first laser light and the second laser light is that the first laser light is laser light having a higher absorption rate to the workpiece than that of the second laser light, and the second laser light is laser light having a better light quality (small beam parameter products (BPP) or M square (M2)) than that of the first laser light.

In the above-described exemplary embodiment, the case where the power of the second laser light (infrared laser light in the case of the exemplary embodiment) is increased after the detection of the surface oxidation has been described, but the power of the second laser light may be increased after the detection of the surface melting. That is, the “surface oxidation” of the above-described exemplary embodiment may be read as the “surface melting”. The surface melting can be detected by a change in the power of the reflected light of infrared laser light L2 from the surface of workpiece 1. The surface melting can also be detected by an image recognition.

In short, at an initial processing stage before a surface oxidation and/or surface melting of a workpiece, a first irradiation step of irradiating the workpiece with at least laser light having a first wavelength, a surface state detection step of detecting the surface oxidation and/or surface melting of the workpiece, and after the surface oxidation and/or surface melting is detected in the surface state detection step, a second irradiation step of irradiating the workpiece with laser light having a second wavelength, which is different from the first wavelength, may be included, in which the laser light having the second wavelength with which the workpiece is irradiated in the second irradiation step may have a power higher than the power before the surface oxidation and/or surface melting is detected.

Since the surface oxidation occurs before the surface melting when an irradiation timing or a power increasing timing of the laser light having the second wavelength is switched based on the surface oxidation, the laser light having the second wavelength can be applied to the workpiece from an earlier stage, and therefore the time required for the processing can be shortened. On the other hand, when the irradiation timing or the power increasing timing of the laser light having the second wavelength is switched based on the surface melting, the absorption rate of the laser light having the second wavelength with respect to the workpiece is increased more reliably, and the laser light having the second wavelength can be applied to the workpiece from an earlier stage, thereby the power consumption required for the processing can be reduced.

The irradiation timing or the power increasing timing of the laser light having the second wavelength may be switched based on both the surface oxidation and the surface melting. By doing so, it is possible to achieve both reduction in processing time and power consumption.

### <4> Round-Up

One aspect of a laser processing method of the present disclosure includes: a first irradiation step of irradiating a workpiece with at least blue laser light at an initial processing stage before a surface oxidation of the workpiece; an oxidation detection step of detecting the surface oxidation of the workpiece; and a second irradiation step of irradiating, after the surface oxidation is detected, the workpiece with infrared laser light having a power higher than a power (including 0) before the surface oxidation is detected.

In one aspect of the laser processing method of the present disclosure, in the oxidation detection step, a surface image of the workpiece is acquired, and the surface oxidation is detected based on the surface image.

In one aspect of the laser processing method of the present disclosure, in the oxidation detection step, a discolored region in the surface image is detected, and the surface oxidation is detected based on an area of the discolored region.

One aspect of a laser processing method of the present disclosure includes: a first irradiation step of irradiating the workpiece with at least laser light having a first wavelength at an initial processing stage before a surface oxidation and/or a surface melting of the workpiece; a surface state detection step of detecting the surface oxidation and/or the surface melting of the workpiece; and a second irradiation step of irradiating the workpiece with laser light having a second wavelength which is different from the first wavelength after the surface oxidation and/or the surface melting is detected in the surface state detection step, in which the laser light having the second wavelength, with which the workpiece is irradiated in the second irradiation step, has a power higher than a power before the surface oxidation and/or the surface melting is detected.

One aspect of a laser processing apparatus of the present disclosure includes: a laser light former (blue laser oscillator 101, infrared laser oscillator 102) that forms blue laser light L1 and infrared laser light L2 with which workpiece 1 is irradiated; an oxidation detector (illumination light former 130, camera 140, calculator 150) that detects a surface oxidation of workpiece 1; and output controller 160 that controls a power of blue laser light L1 and infrared laser light L2 output by the laser light former (blue laser oscillator 101, infrared laser oscillator 102), in which output controller 160 controls an output of the laser light former (blue laser oscillator 101, infrared laser oscillator 102) such that before the surface oxidation is detected on workpiece 1, workpiece 1 is irradiated with at least blue laser light L1, and after the surface oxidation is detected on workpiece 1, a power of infrared laser light L2 with which workpiece 1 is irradiated is increased as compared to before the surface oxidation is detected.

In one aspect of the laser processing apparatus of the present disclosure, the oxidation detector has a capture unit (camera 140) that images a surface of workpiece 1 and detects the surface oxidation of workpiece 1 based on a captured image of the capture unit (camera 140).

In one aspect of the laser processing apparatus of the present disclosure, the oxidation detector includes an image recognizer (oxidized region image recognizer 151) that recognizes a discolored region in the surface image, area calculator 152 that calculates an area of the discolored region, and threshold value determiner 153 that performs a detection determination by performing a threshold value determination on the area of the discolored region.

One aspect of a laser processing apparatus of the present disclosure includes: a laser light former that forms first and second laser light having different wavelengths, respectively, as laser light with which a workpiece is irradiated; a surface state detector that detects a surface oxidation and/or a surface melting of the workpiece; and an output controller that controls a power of the first and second laser light output by the laser light former, in which the output controller controls an output of the laser light former such that before the surface oxidation and/or the surface melting is detected on the workpiece, the workpiece is irradiated with at least the first laser light, and after the surface oxidation and/or the surface melting is detected on the workpiece, a power of the second laser light with which the workpiece is irradiated is increased as compared to before the surface oxidation and/or the surface melting is detected.

One aspect of an output control device of a laser processing apparatus of the present disclosure includes: output controller 160 that controls a power of laser light with which workpiece 1 is irradiated; and an oxidation detector (illumination light former 130, camera 140, calculator 150) that detects a surface oxidation of workpiece 1, in which output controller 160 controls a power of laser light L1 and L2 such that before the surface oxidation is detected on workpiece 1, workpiece 1 is irradiated with at least blue laser light L1, and after the surface oxidation is detected on workpiece 1, a power of infrared laser light L2 with which workpiece 1 is irradiated is increased as compared to before the surface oxidation is detected.

One aspect of an output control device of a laser processing apparatus of the present disclosure includes: an output controller that controls a power of laser light with which a workpiece is irradiated; and a surface state detector that detects a surface oxidation and/or a surface melting of the workpiece, in which the output controller controls a power of the laser light such that before the surface oxidation and/or the surface melting is detected on the workpiece, the workpiece is irradiated with at least laser light having a first wavelength, and after the surface oxidation and/or the surface melting is detected on the workpiece, the workpiece is irradiated with laser light having a second wavelength which is different from the first wavelength, and a power of the laser light having the second wavelength, with which the workpiece is irradiated after the surface oxidation and/or the surface melting is detected, is higher than a power before the surface oxidation and/or the surface melting is detected.

According to an aspect of the present disclosure, there is provided a laser processing method including: a first irradiation step of irradiating a workpiece with at least blue laser light at an initial processing stage before a surface oxidation of the workpiece; an oxidation detection step of detecting the surface oxidation of the workpiece; and a second irradiation step of irradiating, after the surface oxidation is detected, the workpiece with infrared laser light having a power higher than a power before the surface oxidation is detected.

In the oxidation detection step of the laser processing method, a surface image of the workpiece is acquired, and the surface oxidation is detected based on the surface image.

In the oxidation detection step of the laser processing method, a discolored region in the surface image is detected, and the surface oxidation is detected based on an area of the discolored region.

According to an aspect of the present disclosure, there is provided a laser processing apparatus including: a laser light former that forms blue laser light and infrared laser light with which a workpiece is irradiated; an oxidation detector that detects a surface oxidation of the workpiece; and an output controller that controls a power of the blue laser light and a power of the infrared laser light output by the laser light former, wherein the output controller causes the laser light former to: before the surface oxidation is detected on the workpiece, irradiate the workpiece with at least the blue laser light; and after the surface oxidation is detected on the workpiece, increasing the power of the infrared laser light with which the workpiece is irradiated as compared to before the surface oxidation is detected.

The oxidation detector has a capture unit that images a surface of the workpiece and detects the surface oxidation of the workpiece based on a captured image of the capture unit.

The oxidation detector includes: an image recognizer that recognizes a discolored region in the surface image; an area calculator that calculates an area of the discolored region; and a threshold value determiner that performs a detection determination by performing a threshold value determination on the area of the discolored region.

According to an aspect of the present disclosure, there is provided an output control device of a laser processing apparatus including: an output controller that controls a power of laser light with which a workpiece is irradiated; and an oxidation detector that detects a surface oxidation of the workpiece, wherein the output controller controls the power of the laser light to: before the surface oxidation is detected on the workpiece, irradiate the workpiece with at least blue laser light; and after the surface oxidation is detected on the workpiece, increase a power of infrared laser light with which the workpiece is irradiated as compared to before the surface oxidation is detected.

According to the present disclosure, laser processing with high quality and high speed can be performed.

The present disclosure has an effect that laser processing with high quality and high speed can be performed, and is widely applicable to a laser processing method, a laser processing apparatus, and an output control device of a laser processing apparatus which perform welding, cutting, or the like.

What is claimed is:

1. A laser processing method comprising:
a first irradiation step of irradiating a workpiece with at least laser light having a first wavelength at an initial processing stage before at least one of a surface oxidation and a surface melting of the workpiece;
a surface state detection step of detecting the at least one of the surface oxidation and the surface melting of the workpiece; and
a second irradiation step of irradiating the workpiece with laser light having a second wavelength which is different from the first wavelength after the at least one of the surface oxidation and the surface melting is detected in the surface state detection step,
wherein the laser light having the second wavelength with which the workpiece is irradiated in the second irradiation step has a power higher than a power before the at least one of the surface oxidation and the surface melting is detected.

2. A laser processing apparatus comprising:
a laser light former that forms first laser light and second laser light having different wavelengths, respectively, as laser light with which a workpiece is irradiated;
a surface state detector that detects at least one of a surface oxidation and a surface melting of the workpiece; and
an output controller that controls a power of the first laser light and a power of the second laser light output by the laser light former,
wherein the output controller causes the laser light former to:
before the at least one of the surface oxidation and the surface melting is detected on the workpiece, irradiate the workpiece with at least the first laser light; and
after the at least one of the surface oxidation and the surface melting is detected on the workpiece, increasing the power of the second laser light with which the workpiece is irradiated as compared to before the at least one of the surface oxidation and the surface melting is detected.

3. An output control device of a laser processing apparatus comprising:
an output controller that controls a power of laser light with which a workpiece is irradiated; and
a surface state detector that detects at least one of a surface oxidation and a surface melting of the workpiece,
wherein the output controller controls the power of the laser light to:
before the at least one of the surface oxidation and the surface melting is detected on the workpiece, irradiate the workpiece with at least laser light having a first wavelength, and
after the at least one of the surface oxidation and the surface melting is detected on the workpiece, irradiate the workpiece with laser light having a second wavelength which is different from the first wavelength, and increase a power of the laser light having the second wavelength with which the workpiece is irradiated after the at least one of the surface oxidation and the surface melting is detected to be higher than a power before the at least one of the surface oxidation and the surface melting is detected.
